(19) United States
(12) Patent Application Publication
(10) Pub. No.: US 2007/0260485 A1
(43) Pub. Date: Nov. 8, 2007

(54) Healthcare system

(76) Inventors: Tadashi Shibata, Kobe-shi (JP); Dai Furuie, Takasago-shi (JP); Takeyoshi Fujiwara, Miki-shi (JP)

Correspondence Address: BRINKS HOFER GILSON & LIONE, P.O. BOX 10395, CHICAGO, IL, 60610, US

(21) Appl. No.: 11/729,634

(22) Filed: Mar. 29, 2007

(30) Foreign Application Priority Data
Mar. 30, 2006 (JP) 2006-093758

(51) Int. Cl. G06Q 50/00

(52) U.S. Cl. 705/2

(57) ABSTRACT

A healthcare system including: a store-specific terminal accepts and transmits an ID of a user, daily life information on daily life of the user, and biological information on the user; health information registering system generates healthcare support information used for healthcare of the user based on at least the daily life information and has a database for registering the ID, the daily life information, and the biological information on the user and the healthcare support information; and a user terminal outputs the healthcare support information registered in the database.

### RELATED APPLICATIONS

This application claims priority under 35 U.S.C. § 119 to Japanese Patent Application No. JP2006-093758 filed Mar. 30, 2006, the entire content of which is hereby incorporated by reference.

### FIELD OF THE INVENTION

The present invention relates to healthcare systems. More specifically, the present invention relates to a healthcare system for providing information for supporting health to each user based on daily life information on the daily life of the user and biological information on the user.

### BACKGROUND OF THE INVENTION

Recently, people are becoming more interested in health, and a great number of health supplements, health appliances etc. for maintaining and improving health are being sold.

Furthermore, a great number of health performance measuring devices or systems for determining the health performance of the user based on information acquired from a user or customer (hereinafter collectively referred to as “user”) are being proposed. Some devices or systems determine the health performance based only on a result of a questionnaire replied by the user, but other devices or systems determine the health performance of the user based on the questionnaire result and biological information such as blood pressure, pulse etc. of the user, and display the health performance (see e.g., Japanese Laid-Open Patent Publication No. 11-318830).

The device described in Japanese Laid-Open Patent Publication No. 11-318830 simply displays the health performance of the user, whereby the user is able to know his/her health performance but is unable to understand what kind of food to eat or what kind of health supplement to take in order to improve the health performance even if the health performance is displayed as low.

The applicant has thus proposed a sales support system that allows product selecting support information, which are determined based on the daily life information on the user input from a store-specific terminal installed in a store in advance, to be browsed with a seller's device, and enables the seller to easily select a product suitable for the user and to recommend such a product to the user.

The present invention aims to provide a healthcare system, modified from the conventional system, for acquiring the health support information based on the daily life information on the user and the biological information measured in the store in the past not only from the store-specific terminal installed in the store but also from the user terminal installed in a house etc. of the user, and allowing his/her own health management to be easily performed at any time.

### SUMMARY OF THE INVENTION

The scope of the present invention is defined solely by the appended claims, and is not affected to any degree by the statements within this summary.

A first aspect of the present invention is a healthcare system comprising: a store-specific terminal including: first input means for accepting an ID of a user, daily life information on daily life of the user, and biological information on the user; and first transmitting means for transmitting the ID, the daily life information and the biological information on the user accepted by the first input means; health information registering system including: first receiving means for receiving the ID, the daily life information and the biological information on the user transmitted from the store-specific terminal, generating means for generating healthcare support information used for healthcare of the user based on at least the daily life information received by the first receiving means, and a database for registering the ID, the daily life information, and the biological information on the user received by the first receiving means and the healthcare support information generated by the generating means; and a user terminal including an output means for outputting the healthcare support information registered in the database; wherein the user terminal includes: second input means for accepting the ID of the user; and second transmitting means for transmitting the ID of the user accepted by the second input means, wherein the health information registering system includes: second receiving means for receiving the ID of the user transmitted from the user terminal; searching means for searching from the database the healthcare support information corresponding to the ID of the user received by the second receiving means; and third transmitting means for transmitting the healthcare support information searched by the searching means to the user terminal.

A second aspect of the present invention is a healthcare system comprising: a health information registering system including: first storage means for storing user specifying information for specifying a user and healthcare support information used for healthcare of the user in association with each other; and second storage means for storing, in association with each other, the user specifying information and second user specifying information for specifying a second user permitted by the user specified by the user specifying information to browse the healthcare support information; and a user terminal including output means for outputting the healthcare support information registered in the healthcare information registering system; wherein the user terminal includes: request means for requesting to log-in the healthcare registering system, the health information registering system includes: authenticating means for executing log-in authentication in response to a log-in request accepted from the user terminal; first acquiring means for acquiring from the second storage means the second user specifying information corresponding to the specifying information for specifying the user authenticated by the authenticating means; second acquiring means for acquiring from the first storage means healthcare support information corresponding to the second user specifying information acquired by the first acquiring means; and second transmitting means for transmitting to the user terminal the healthcare support information acquired by the second acquiring means.

A third aspect of the present invention is a healthcare information registering device comprising: first storage means for storing user specifying information for specifying a user and healthcare support information used for healthcare of the user in association with each other; second storage means for storing in association with each other the user specifying information and second user specifying information for specifying a second user permitted by the user specified by the user specifying information to browse the healthcare support information; authenticating means for executing log-in authentication in response to a log-in request accepted from a user terminal; first acquiring means for acquiring from the second storage means second user specifying information corresponding to the specifying information for specifying the user authenticated by the authenticating means; second acquiring means for acquiring from the first storage means healthcare support information corresponding to the second user specifying information acquired by the first acquiring means; and second transmitting means for transmitting the second user healthcare support information acquired by the second acquiring means to the user terminal.

### BRIEF DESCRIPTION OF THE DRAWINGS

FIG. 1 is an explanatory view of one embodiment of a healthcare system of the present invention;

FIG. 2 is a perspective view showing an entire configuration example on a store side in the healthcare system of the present invention;

FIG. 3 is a frame format view for explaining the configuration shown in FIG. 2;

FIG. 4 is a frame format view for explaining a configuration of a controller of a store-specific terminal in the healthcare system of the present invention;

FIG. 5 is a frame format view for explaining a configuration of a controller of a seller's terminal in the healthcare system of the present invention;

FIG. 6 is a frame format view for explaining a configuration of a controller of a server in the healthcare system of the present invention;

FIG. 7 is a view showing the concept of process flows of the store-specific terminal, the server, and the seller's terminal of the healthcare system of the present invention;

FIG. 8 is a view showing a report printed by the store-specific terminal in step S53 shown in FIG. 7;

FIG. 9 is a view showing an image in step S74 shown in FIG. 7;

FIG. 10 is a view showing an example of a display screen of health support information including past history of a user;

FIG. 11 is a view showing an ID card used in the healthcare system of the present invention;

FIG. 12 is a view showing an example of a display screen of a touch panel when starting a process in the store-specific terminal;

FIG. 13 is a view showing an example of a display screen of the touch panel after basic information is input in the store-specific terminal;

FIG. 14 is a view showing a configuration of data stored in an ID card DB shown in FIG. 6;

FIG. 15 is a flow chart illustrating a flow of a process for membership registration;

FIG. 16 is a flow chart illustrating a flow of healthcare information display process;

FIG. 17 is a flow chart illustrating a flow of a questioning process using the internet; and

FIG. 18 is a view describing an example of a business model using the healthcare system of the present invention.

### DETAILED DESCRIPTION OF THE PREFERRED EMBODIMENT

Embodiments of a healthcare system of the present invention will now be described in detail with reference to the accompanying drawings.

[Entire Configuration of System]

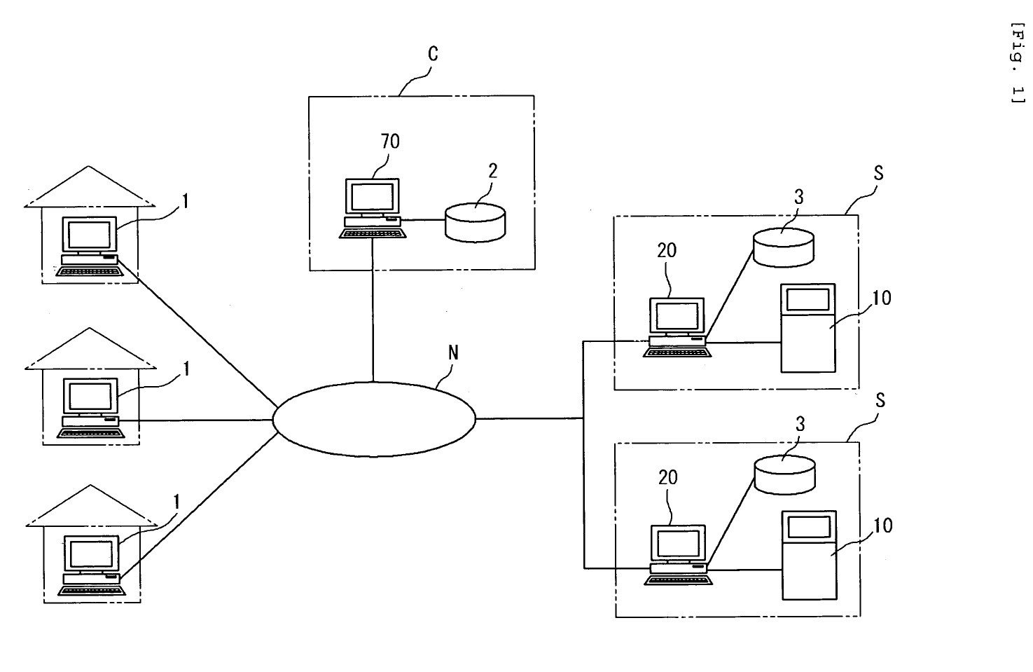

FIG. 1 is an explanatory view of a healthcare system according to one embodiment of the present invention. The healthcare system according to the present embodiment includes a store-specific terminal 10, arranged in a store S, having an input means for accepting daily life information on daily life of a user and biological information on the user; a user terminal 1 having an input means for accepting the daily life information on the user; a server 70 communicably connected to the store-specific terminal 10 and the user terminal 1 by way of a network N; and a seller's terminal 20, installed in the store S, communicably connected to the store-specific terminal 10. In the present embodiment, there are provided a plurality of databases, that is, a first database storing the daily life information and the biological information in association with the user; a second database storing health support information based on at least the daily life information out of the daily life information and the biological information; a third database storing product information for maintaining or improving health condition of the user based on at least the daily life information out of the daily life information and the biological information; and a fourth database storing advice information for maintaining or improving the health condition of the user based on at least the daily life information out of the daily life information and the biological information, and these first to fourth databases are included in a database 2 of a center C that controls a entire system. In the present embodiment, a database 3 of the each store S is used to temporarily store various information.

The server 70 manages data collected from a plurality of store-specific terminals 10 and user terminals 1 and provides a website to be hereinafter described, through which website the user may perform questioning or may reference his/her past daily life information or biological information.

When the healthcare system of the present invention is run by a specific industrial group, the server 70 is installed in one store out of a group of stores of the industrial group, where the server 70 is connected to the store-specific terminal 10 by way of a network such as LAN in the one store, and the server 70 may also be communicably connected to the store-specific terminals 10 of other stores and the user terminals 1 by way of a network such as the internet.

[Configuration on Store Side]

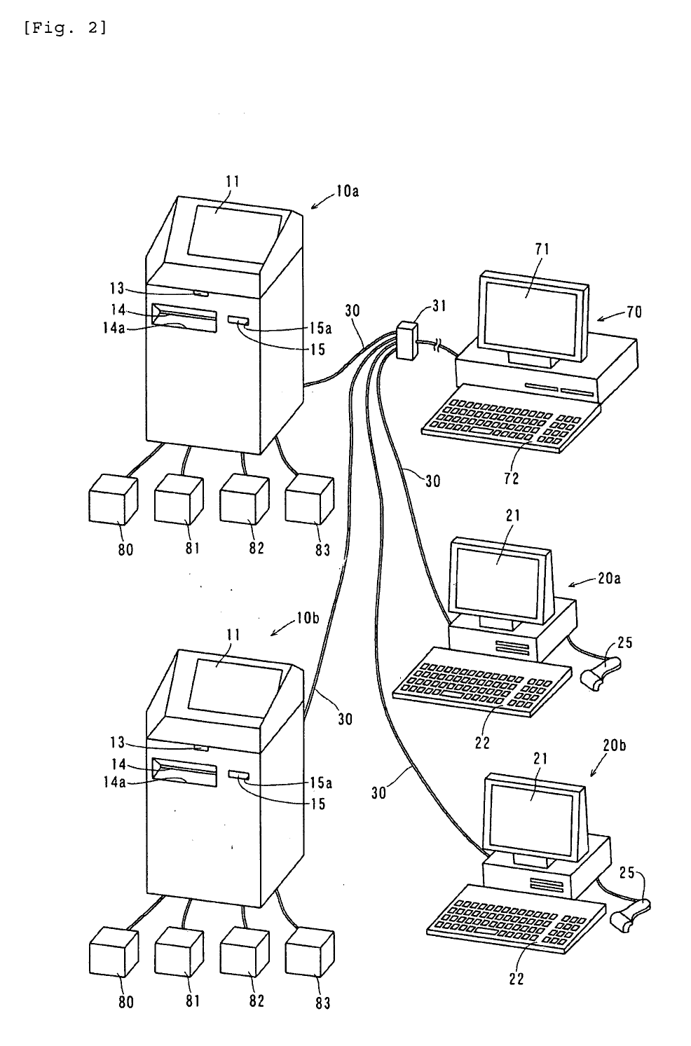

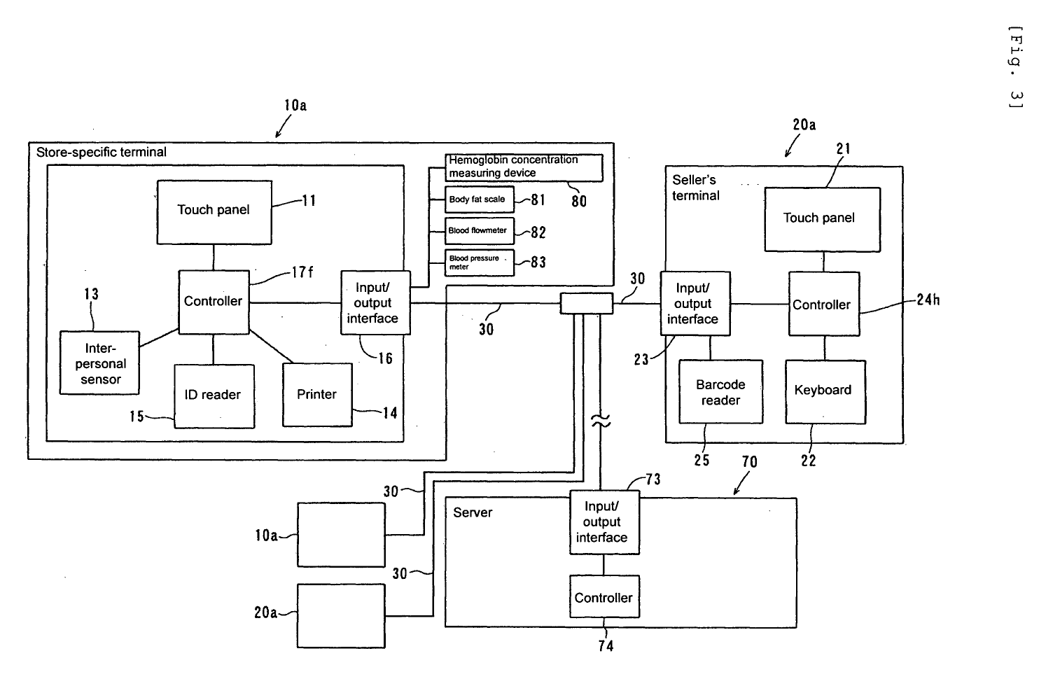

FIG. 2 is a perspective view showing an entire configuration example on a store side in the healthcare system of the present invention, and FIG. 3 is a frame format view for explaining the configuration shown in FIG. 2.

In the present embodiment, a device on the store side includes a store-specific terminal 10a, another store-specific terminal 10b, a seller's terminal 20a, and another seller's terminal 20b, which are communicably connected to the server 70 by way of the internet (network), as shown in FIG. 2. To simplify the drawing, only the one store-specific terminal 10b and the one seller's terminal 20b are shown in the present embodiment, but two or more of those terminals may be connected. The store-specific terminals 10a and 10b and the seller's terminals 20a and 20b are connected to the server 70 by way of LAN cables 30, a hub 31, and a public line. Furthermore, the store-specific terminal 10a and the seller's terminal 20a are installed in a predetermined pharmacy, and the another store-specific terminal 10b and the another seller's terminal 20b are installed in another pharmacy belonging to the same industrial group as the predetermined pharmacy in the present embodiment. The store-specific terminals 10a and 10b, and the seller's terminals 20a and 20b respectively have the same configurations. In the present embodiment, the store-specific terminal 10a is provided with a touch panel 11, an interpersonal sensor 13, a printer 14, an ID reader 15, an input/output interface 16 connected to the LAN cable 30, and a controller 17f, as shown in FIG. 3. The touch panel 11, the inter-personal sensor 13, the printer 14, the ID reader 15 and the input/output interface 16 are connected to the controller 17f.

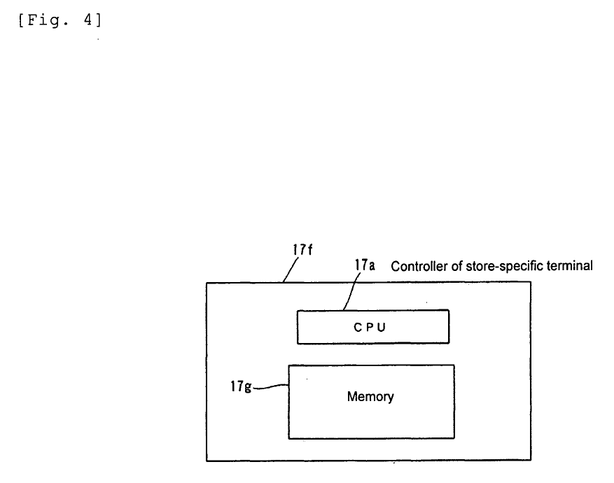

In the present embodiment, a hemoglobin concentration measuring device 80, a body fat scale 81, a blood flowmeter 82 and a blood pressure meter 83 for measuring the biological information on the user are connected to the input/output interface 16 of the store-specific terminal 10a, and the measurement results of the hemoglobin concentration, percent of body fat, blood flow, and blood pressure value are transmitted thereto. Furthermore, the controller 17f of the store-specific terminal 10a includes a CPU 17a and a memory 17g, as shown in FIG. 4. A blood sugar level, body temperature, pulse etc. may be used as the biological information in addition to the above.

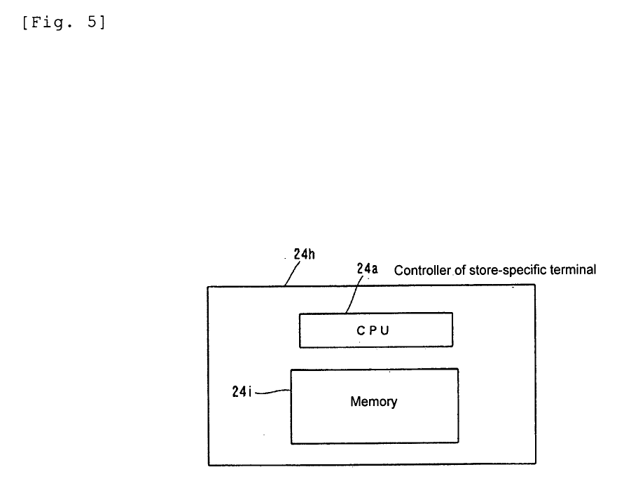

In the present embodiment, the seller's terminal 20a is provided with a touch panel 21, a keyboard 22, an input/output interface 23 connected to the LAN cable 30, a controller 24h, and a barcode reader 25 connected to the input/output interface 23, as shown in FIG. 3. The touch panel 21, the keyboard 22, and the input/output interface 23 are connected to the controller 24h. The controller 24h of the seller's terminal 20a includes a CPU 24a and a memory 24i, as shown in FIG. 5.

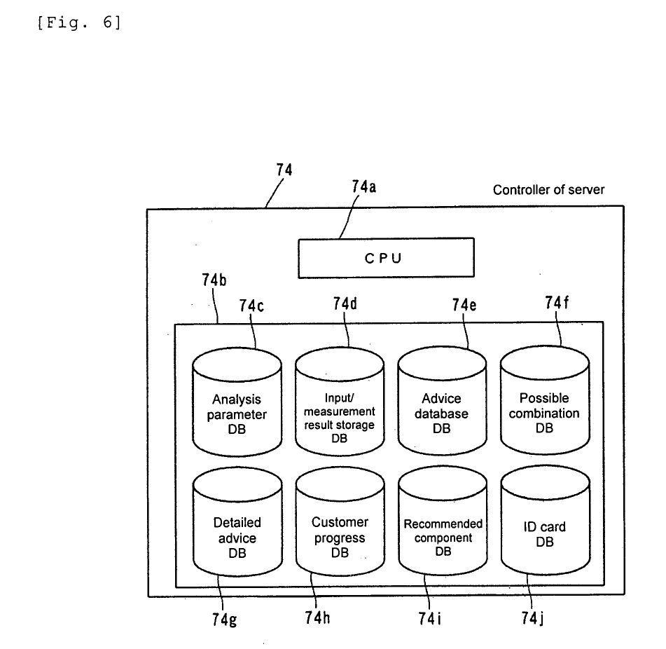

Moreover, in the present embodiment, an input/output interface 73 and a controller 74 connected to the input/output interface 73 are arranged in the server 70, as shown in FIG. 3. The controller 74 includes a CPU 74a and a memory 74b, as shown in FIG. 6. The memory 74b includes an analysis parameter DB 74c, an input/measurement result storage DB 74d serving as the first database, an advice data DB 74e configuring the second database, a possible combination DB 74f configuring the third database, a detailed advice DB 74g serving as the fourth database, a customer progress DB 74h, a recommended component DB 74i configuring the third database, and an ID card DB 74j.

[Process Flow of Store-Specific Terminal]

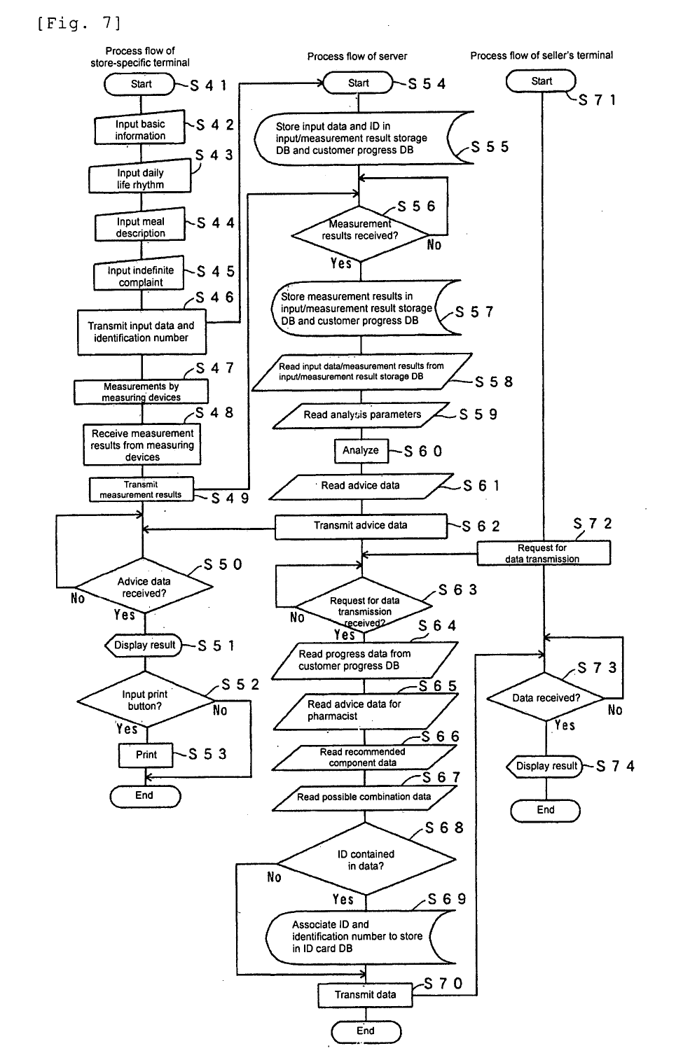

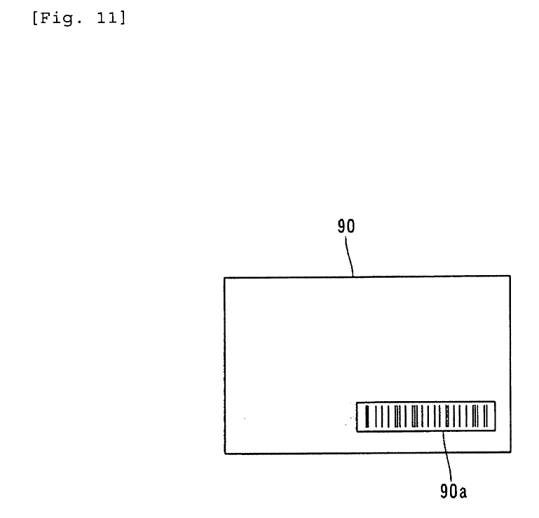

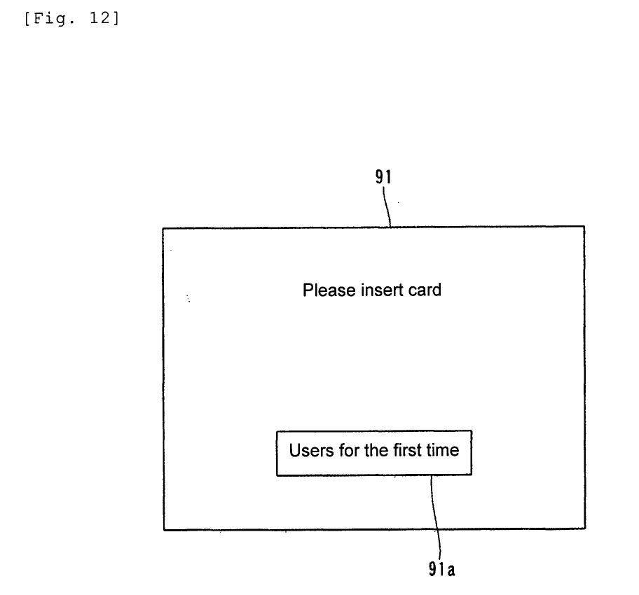

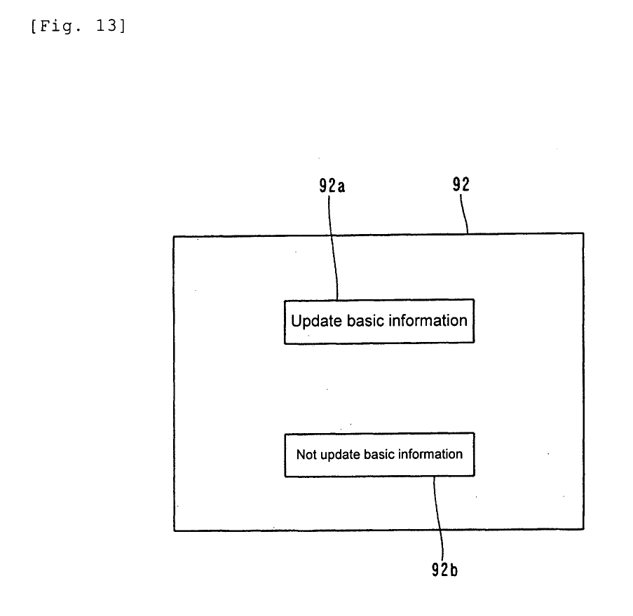

The process flow in a case of using the healthcare system according to the present embodiment in the store will now be described. First, in step S41 of FIG. 7, a display screen 91 shown in FIG. 12 is displayed on the touch panel 11 when the user stands in front of the store-specific terminal 10a. The process starts when an ID card 90 shown in FIG. 11 is inserted to an insert slot 15a, or a “users for the first time” button 91a on a lower part of the display screen 91 displayed on the touch panel 11 is touched. If the process is started using the ID card 90, an ID (membership number) included in a barcode 90a printed on the ID card 90 is read by the ID reader 15. After the ID (membership number) is read, a display screen 92 shown in FIG. 13 is displayed on the touch panel 11, and the process proceeds to step S42 when an “update basic information” button 92a on an upper part of the display screen 92 is touched. Then in step S42, the basic information is input by the user. When the user inputs the basic information, a basic information input screen (not shown) for inputting the basic information such as sex, age, height, weight etc. of the user is displayed on the touch panel 11 of the store-specific terminal 10a (see FIG. 2). After inputting the basic information by touching a predetermined portion of the basic information input screen on the touch panel 11 with a finger, the user touches a “next” button on the basic information input screen. However, information that specifies the user such as name, address etc. of the user is not input at this point. The input of the basic information is thereby completed. Subsequently, daily life rhythm is input by the user in step S43 of FIG. 7. When the user inputs the daily life rhythm, a work description input screen and a sleeping hour input screen (not shown) are displayed on the touch panel 11. In this case, the user first inputs the daily life rhythm such as description of work and working hours of the user on the work description input screen, and then touches the button on the work desciption input screen. The input of the daily life rhythm is thereby completed. The user thereafter inputs the sleeping hours on the sleeping hour input screen (not shown). Then in step S44, meal description is input by the user. When the user inputs the meal description, a meal description input screen is displayed on the touch panel 11 of the store-specific terminal 10a. After inputting the meal description on the meal description input screen on the touch panel 11, the user touches a button on the meal description input screen. The input of the meal description is thereby completed. When the display screen 92 shown in FIG. 13 is displayed on the touch panel 11 in step S41, and a “not update basic information” button 92b on the lower part of the display screen 92 is touched, the basic information inputs screen and the work description input screen are not displayed, but the meal description input screen is displayed.

Subsequently, in the present embodiment, a plurality of questions on symptom (indefinite complaint) felt by the user is displayed on the touch panel 11 as information on the daily life of the user in step S45 of FIG. 7, and the user inputs answers to the plurality of questions on the indefinite complaint. The questions on the symptom (indefinite complaint) felt by the user include “have chills in limbs and hip”, “often get sleepy”, etc. In step S46, the ID, basic information, daily life rhythm, meal description, and indefinite complain of the user, input in steps S41 to S45, are transmitted to the server 70 (see FIG. 2). Furthermore, in step S46, an identification number indicating an analysis for this time is determined, and the identification number is transmitted to the server 70.

In step S47 of FIG. 7, screens urging the user to perform measurements with the hemoglobin concentration measuring device 80, the body fat scale 81, the blood flowmeter 82, and the blood pressure meter 83 are sequentially displayed on the touch panel 11, and the user measures the hemoglobin concentration, the percent of body fat, the amount of blood volume and the blood pressure value respectively according to the respective screens with the hemoglobin concentration measuring device 80 (see FIG. 2), the body fat scale 81, the blood flowmeter 82, and the blood pressure meter 83. When measuring the hemoglobin concentration, the measurement screen is first displayed on the touch panel 11 of the store-specific terminal 10a. The user follows instructions on the measurement screen, and inserts the middle finger of his/her left hand in an insert section (not shown) of the hemoglobin concentration measuring device 80 of the store-specific terminal 10a, and touches a “start” button on the measurement screen on the touch panel 11 with another finger. The hemoglobin concentration of the user is thereby measured by the hemoglobin concentration measuring device 80. The measurements of the percent of body fat, the amount of blood flow, and the blood pressure value are also sequentially performed in accordance with the instructions on the measurement screens on the touch panel 11, similarly to the measurement of the hemoglobin concentration. Then in step S48 of FIG. 7, measurement results of the hemoglobin concentration, the percent of body fat, the amount of blood flow, and the blood pressure value are received by the controller 17f from the hemoglobin concentration measuring device 80, the body fat scale 81, the blood flowmeter 82, and the blood pressure meter 83. In step S49 of FIG. 7, the measurement results received by the controller 17f are transmitted to the server 70.

Then in step S50, It is determined whether or not advice data is received from the server 70. If determined that the advice data is not received from the server 70 in step S50, such determination is repeated. If determined that the advice data is received from the server 70 thereafter in step S50, the received advice data is displayed in step S51. Specifically, an analysis result display screen showing health support information for suggesting maintenance or improvement of the health of the user is displayed on the touch panel 11.

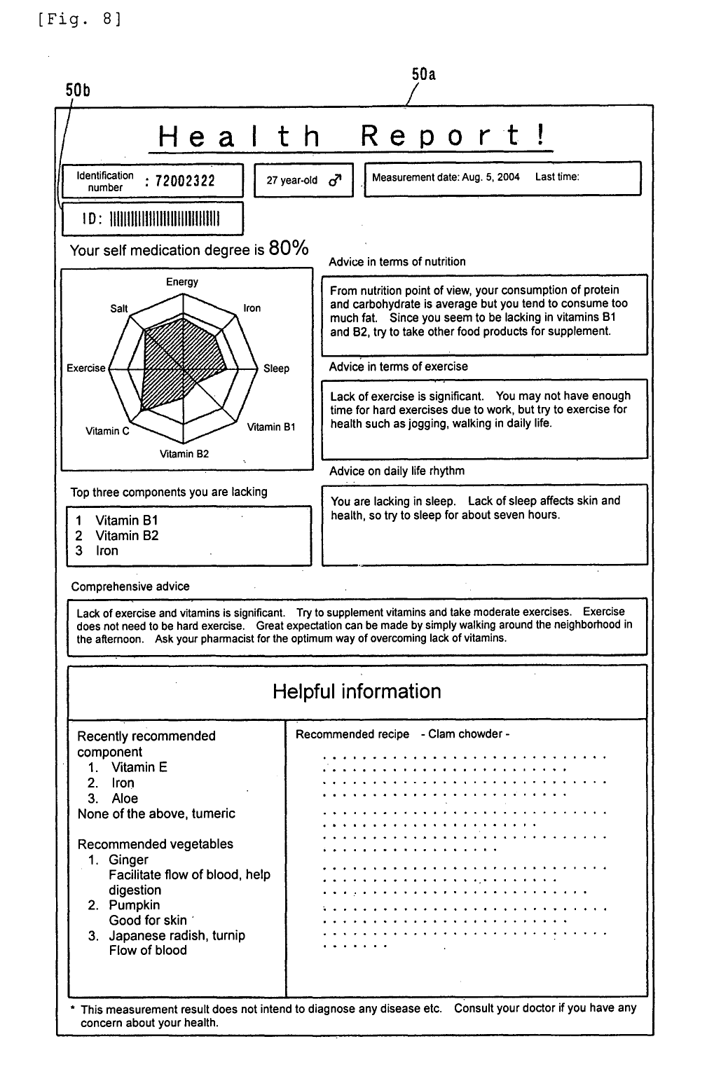

If the user touches a “print” button on the analysis result screen in step S52, a report 50a (see FIG. 8) is printed in step S53. The printed report 50a is discharged from a report discharge slot 14a (see FIG. 2). In the report 50a shown in FIG. 8, the identification number is printed, and a barcode 50b including the identification number indicating the analysis for this time determined in step S46 is displayed on a lower side. Various advice information, helpful information and the like configuring the health support information are printed on other portions of the report 50a.

[Process Flow of Server]

A process flow of the server 70 in the present embodiment will now be described. The process starts when the ID, basic information, daily life rhythm, meal description, and indefinite complaint of the user input in steps S41 to S45 (see FIG. 7) and the identification number determined in step S46 are transmitted from the store-specific terminal 10a. This process is on one set of the store-specific terminal 10a and the seller's terminal 20a, and a process on the store-specific terminal 10b and the seller's terminal 20b is executed in parallel with the above process if input data are transmitted from the another store-specific terminal 10b and seller's terminal 20b.

First, in step S54, the process in the server 70 starts when the input data (ID, basic information, daily life rhythm, meal description and indefinite complaint of the user) and the identification number are received from the store-specific terminal 10a (see FIG. 2) via the LAN cable 30 (see FIG. 2), the hub 31 and the like. In step S55, the received input data are stored in the input/measurement result storage DB 74d and the customer progress DB 74h of the memory 74b of the server 70 (see FIG. 6) in association with the identification number. In step S56, it is determined whether or not the measurement results are received from the store-specific terminal 10a. If determined that the measurement results are not received from the store-specific terminal 10a in step S56, such determination is repeated. If determined that the measurement results are received from the store-specific terminal 10a in step S56, the received measurement results are stored in the input/measurement result storage DB 74d and the customer progress DB 74h of the memory 74b of the server 70 in association with the identification number in step S57.

In step S58, the input data of the ID, basic information, daily life rhythm, meal description and indefinite complaint of the user input in steps S41 to S45, and the measurement results (including history of measurement results) measured in step S47 are read from the input/measurement result storage DB 74d (see FIG. 6) of the memory 74b. Subsequently, in step S59, the analysis parameters are read from the analysis parameter DB 74c of the memory 74b. In step S60, the health condition of the user is analyzed through analysis algorithm such as Bayesian network based on the input data and the measurement results read in step S58 and the analysis parameter read in step S59. The analysis result based on the input data and the measurement results is determined as a result. The analysis result is data (code) for specifying one advice data out of a plurality of advice data stored in the advice data DB 74e (see FIG. 6). Specifically, the analysis result is expressed in alphabets and numerical values, and is associated with one of the plurality of advice data stored in the advice data DB 74e. The analysis result is further associated with one of a plurality of recommended component data stored in the recommended component DB 74i (see FIG. 6). Moreover, the analysis result is associated with one of the advice data for a plurality of pharmacists (sellers) stored in the detailed advice DB 74g (see FIG. 6). The analysis result is also associated with one of a plurality of possible combination data stored in the possible combination DB 74f (see FIG. 6). The analysis result is furthermore associated with the identification number received in step S54.

In step S61, the advice data corresponding to the analysis result of the health condition of the user determined in step S60 is selected and read from the advice data DB 74e (see FIG. 6). Subsequently, the advice data read in step S61 is transmitted to the store-specific terminal 10a in step S62. In step S63, it is determined whether or not data requesting for data transmission is received from the seller's terminal 20a. The data requesting for data transmission includes the identification number indicating the analysis for this time input to the seller's terminal 20a. The identification number is used to identify the input data, the measurement results, the advice data for the pharmacist, the recommended component data, and the possible combination data in steps S64 to S67. If determined that the data requesting for data transmission is not received from the seller's terminal 20a in step S63, such determination is repeated. Then, if determined that the data requesting for data transmission is received from the seller's terminal 20a in step S63, the input data and the measurement results (including history of measurement results) corresponding to the identification number transmitted from the seller's terminal 20a are read from the customer progress DB 74h (see FIG. 6) in step S64.

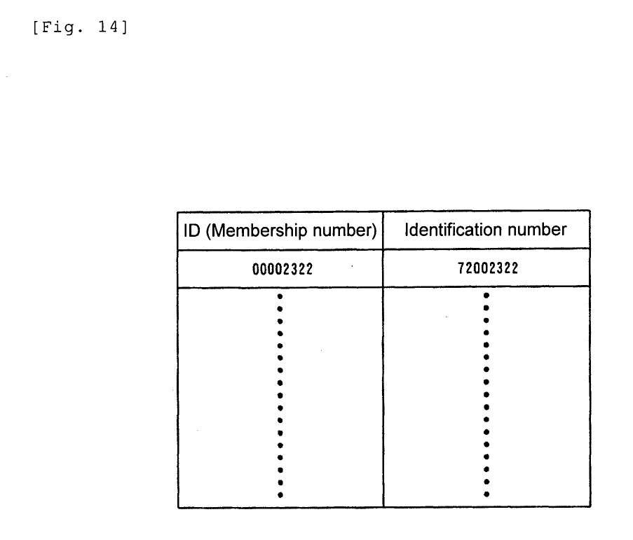

Subsequently, in step S65, the advice data for the pharmacist corresponding to the analysis result corresponding to the identification number transmitted from the seller's terminal 20a is selected and read from the advice data for the plurality of pharmacists stored in the detailed advice DB 74g (see FIG. 6). In step S66, the recommended component data corresponding to the analysis result corresponding to the identification number transmitted from the seller's terminal 20a is selected and read from the plurality of recommended component data stored in the recommended component DE 74i (see FIG. 6). Subsequently, in step S67, the possible combination data corresponding to the analysis result corresponding to the identification number transmitted from the seller's terminal 20a is selected and read from the plurality of possible combination data stored in the possible combination DB 74f (see FIG. 6). Then in step S68, it is determined whether or not the ID (membership number) is included in the data. If determined that the ID (membership number) is included in the data, the ID (membership number) and the identification number are associated with each other and stored in the ID card DB 74j, as shown in FIG. 14 in step S69. If determined that the ID (membership number) is not included in the data in step S68, the process proceeds to step S70. In step S70, the data read in steps S64 to S67 are transmitted to the seller's terminal 20a.

[Process Flow of Seller's Terminal]

A process flow of the seller's terminal 20a in the healthcare system according to the present embodiment will now be described. First, in step S71, the process flow of the seller's terminal 20a starts when the pharmacist or the seller inputs the identification number or the ID (membership number) to the seller's terminal 20a. The identification number may be input using the keyboard 22 (see FIG. 2), or may be input by reading the barcode 50b (see FIG. 8) printed on the report 50a printed in step S53 with the barcode reader 25. The ID (membership number) is input by reading the barcode 90a (see FIG. 11) printed on the ID card 90 with the barcode reader 25. In step S72, the data requesting for data transmission is transmitted to the server 70. The data requesting for data transmission includes the identification number input in step S71. Subsequently, in step S73, it is determined whether or not the data read in steps S64 to S67 are received from the server 70. If determined that the data read in steps S64 to S67 are not received from the server 70 in step S73, such determination is repeated.

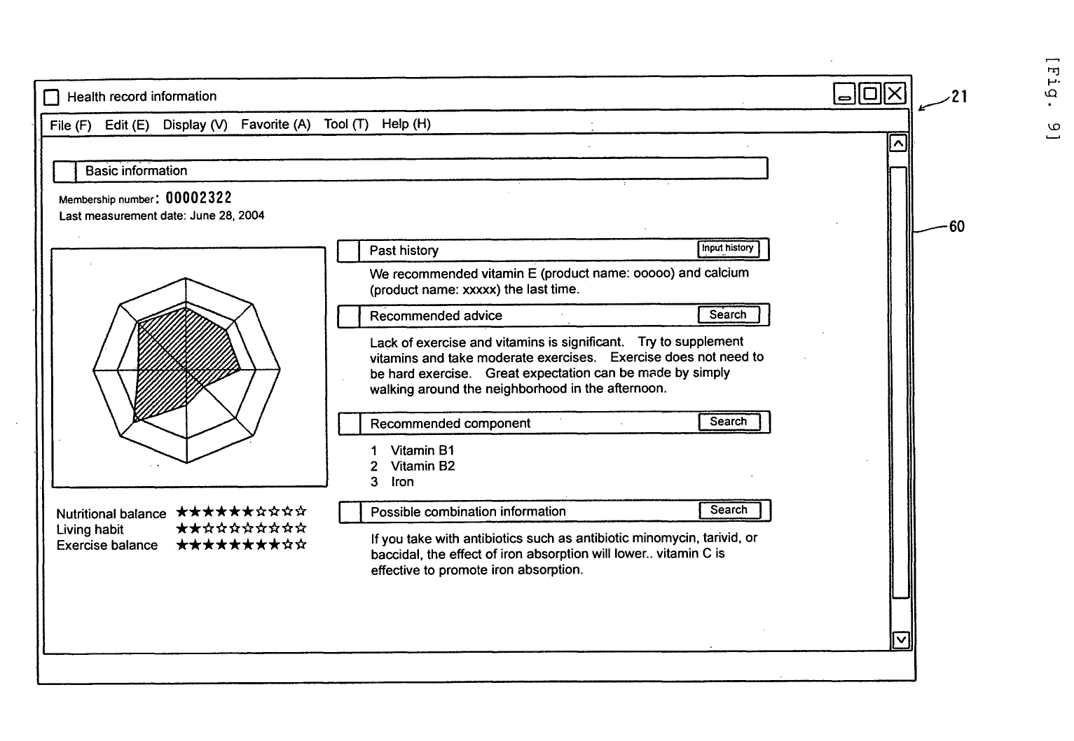

Thereafter, if determined that the data read in steps S64 to S67 are received from the server 70 in step S73, the data received in step S73 are displayed on a recommended information screen (see FIG. 9) in step S74. When such an information screen is displayed, the pharmacist is able to determine what kind of advice to give to the user to maintain or improve health based on the information displayed on a “recommended advice”. The pharmacist may select a product including a component displayed on the column from the information displayed on a “recommended component” as the product the user should purchase to maintain or improve health, and recommend the product to the user.

In the present embodiment, the information (information stored in the recommended component DB 74i) for supporting selection by the pharmacist of the product the user should purchase to maintain or improve health determined by the controller 74 of the server 70 based on the daily life information and the measured biological information input by the user in the store-specific terminal lOa can be transmitted from the server 70 to the seller's terminal 20a and easily displayed on the touch panel 21 of the seller's terminal 20a, by connecting the store-specific terminal 10a and the server 70 by way of the internet, and similarly connecting the seller's terminal 20a and the server 70 by way of the internet, as described above. The pharmacist is thereby able to browse through the information for supporting the selection by the pharmacist of the product the user should purchase displayed on the touch panel 21 of the seller's terminal 20a. Therefore, the pharmacist can easily select the product suitable for the user and recommend the product to the user, based on the information for supporting the selection by the pharmacist of the product the user should purchase. The user can be convinced to purchase the product if the product is recommended by the pharmacist based on the daily life information and the biological information on the user.

In the present embodiment, the biological information collected from all the store-specific terminals 10a and 10b installed in the pharmacies belonging to the same industrial group can be managed in one server 70 by communicably connecting the server 70 to the plurality of store-specific terminals 10a and 10b, and to the plurality of seller's terminal 20a and 20b respectively corresponding to the plurality of store-specific terminals 10a and 10b.

Furthermore, since the memory 74b storing information (information stored in recommended component DB 74i) on the product the user should purchase to maintain or improve health is provided in the server 70, in the present embodiment, a predetermined recommended component can be selected from the recommended component DB 74i without communicating with other devices based on the daily life information and the measured biological information received from the store-specific terminal 10a, thereby achieving a high-speed process.

The pharmacist is able to display the recommended information screen 60 by simply reading the barcode 50b printed on the report 50a or the barcode 90a printed on the ID card 90 in the present embodiment, and thus the process is simple and personal data does not need to be managed since the pharmacist does not need to acquire the personal data that specifies name, address and the like of the user.

Furthermore, the ID card DB 74i for associating and storing the ID (membership number) and the identification number is provided in the present embodiment, as described above, and thus the ID (membership number) can be acquired by reading the barcode 90a printed on the ID card 90 using the barcode reader 25 of the seller's terminal 20a, whereby the data of the identification number corresponding to the acquired ID (membership number) can be read from the each database. The past history corresponding to the ID (membership number) is thereby easily displayed.

An example of using Bayesian network as the analysis algorithm for analyzing the health condition of the user based on the input data, the measurement data, and the analysis parameters has been described in the present embodiment, but the present invention is not limited thereto, and the health condition of the user may be analyzed using analysis algorithms other than Bayesian network.

[Use of System at User Terminal]

The feature of the present invention lies in that questioning can be performed and the past biological information on the user as well as the health support information can be referenced from the user terminal. An example of a process at the user terminal will be described below.

[Registration for Membership]

Registration for membership can be carried out at the each store, but can also be carried out from the user terminal. A member card (ID card) is issued, and a membership ID and a password are assigned to the member.

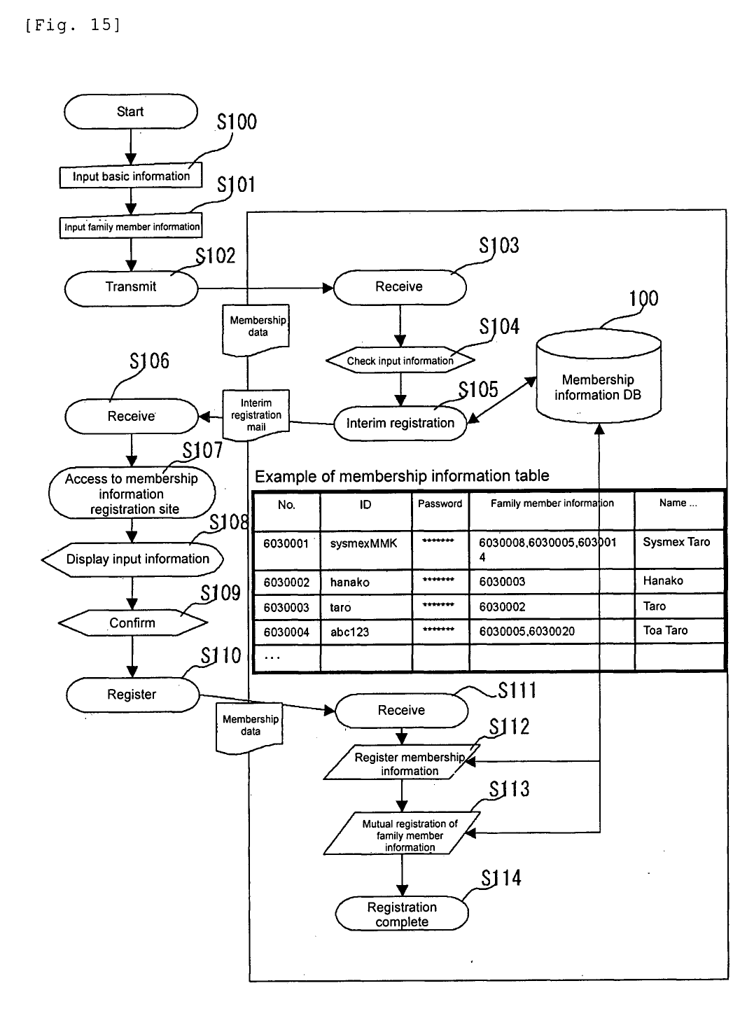

When registering for membership from the user terminal, the basic information (age, height, weight, name etc.) and family member information are first input by input means such as a keyboard and a mouse of the user terminal (step S100 and step S101), as shown in FIG. 15. The input information are transmitted to the server 70 (step S102), and received by the server 70 (step S103).

After the input information are checked in the server 70 (step S104), interim registration is made to a membership information DB100 (step S105).

After the interim registration, an e-mail attached with registration information is transmitted to the user, and received by the user terminal (step S106). (Operation from reception of the e-mail to access to membership registration site?) When the user accesses the a membership registration site (step S107), the input information are displayed on the display means of the user terminal (step S108). After confirming the content (step S109), the user pushes a registration button for the actual registration (step S100), whereby membership data is transmitted to the server 70 and received by the server 70 (step S111). Thereafter, membership information is actually registered to the membership information DB 100 (step S212), and the family member information are mutually registered (step S213) if the family member information are present, whereby registration is completed (step S114).

[Display Process of Health Support Information]

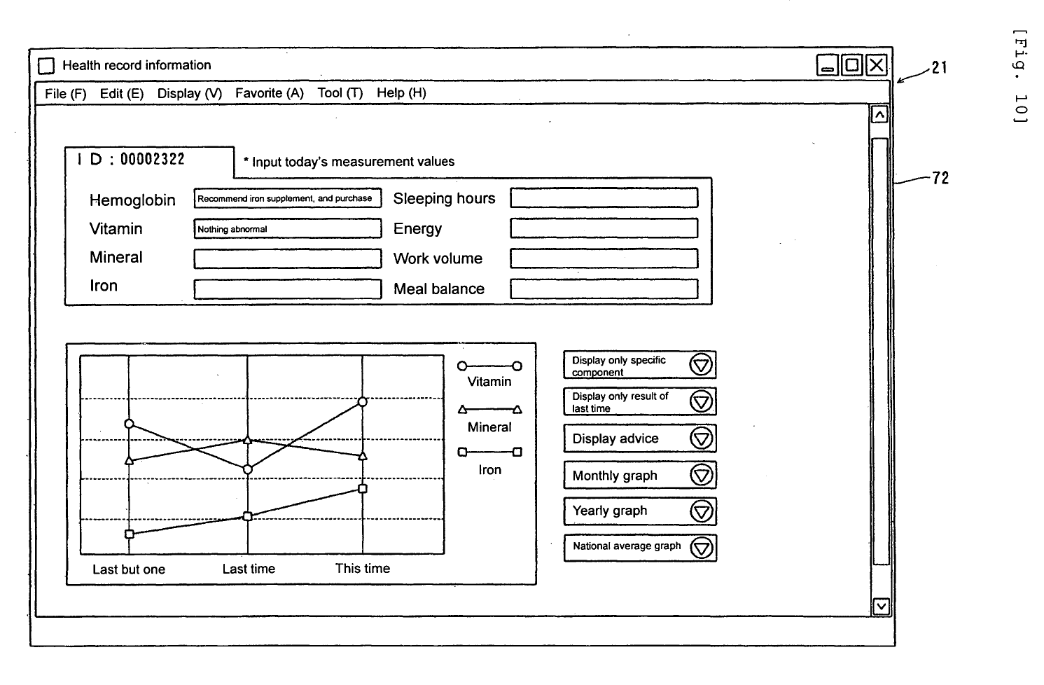

In the present invention, the health support information shown in FIGS. 9 and 10 can be acquired and displayed at the user terminal.

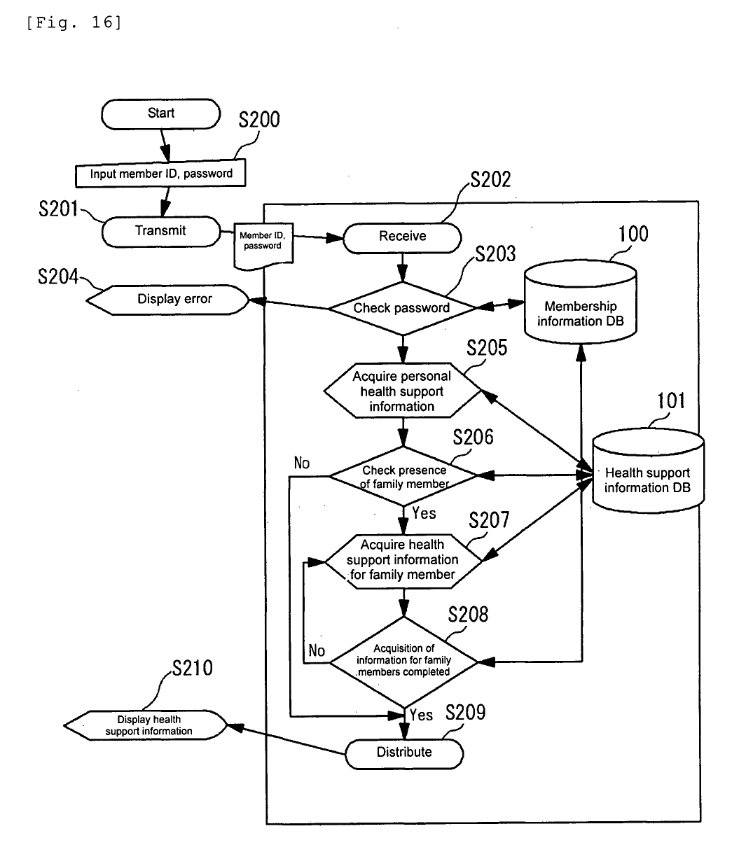

As shown in FIG. 16, an access is made to the website, and the member ID and the password are input in the site (step S200). The input member ID and the password are transmitted to the server 70 (step S201), and received at the server 70 (step S202). Check is made with the password stored in the membership information DB, and error display is made on the display means of the user terminal if a wrong password is input (step S204), and health support managing information on the individual (user) is acquired from the health support information DB 101 if the password is correct (step S205).

Check is made on presence of family member based on the membership information DB 100 (step S206), and the health support managing information on the individual acquired in step S205 is distributed to the user terminal if the family member is not present (step S209), and displayed on the display means of the user terminal (step S210).

If the family member is present, the health support information on the family is acquired from the health support information DB 101 (step S207). check is then made whether or not the health support information have been acquired for all the family members (step S208), and if the health support information have been acquired for all the family members, the health support information on the user himself/herself and his/her family are distributed to the user terminal (step S209), and displayed on the display means of the user terminal (step S210). If a family member whose health support information is not acquired is present, the process returns to step S207 and the health support information for the family member is acquired from the health support information DB 101, and similar processes are repeated until the health support information are acquired for all the family members.

[Questioning From User Terminal]

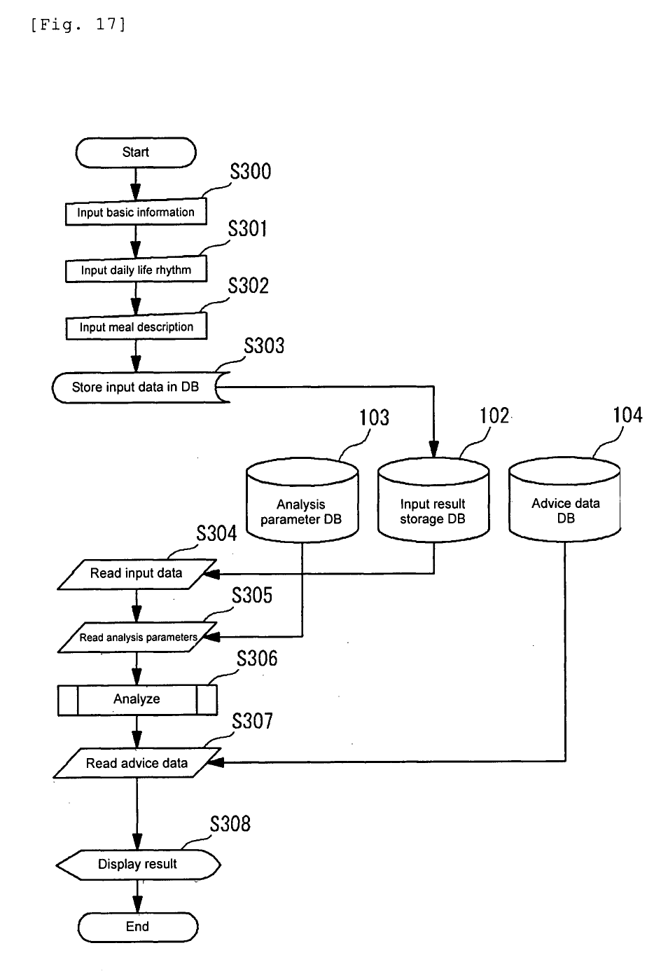

In the healthcare system of the present invention, the daily life information on the user can be input and questioning can be performed using the user terminal without going to the store. FIG. 17 shows a flow of process in a case of performing questioning at the user terminal using the internet.

Access is made to the website, and the basic information (age, height, weight etc.) is input (step S300). The daily life rhythm such as sleeping hours, amount of exercise and the like is input (step S301), and then the meal description is input (step S302). Such information are input in a form of questionnaire by answering questions displayed on the screen. In addition to the daily life rhythm and the meal description, questions on indefinite complaint such as “have chills in limbs and hip”, “often get sleepy” etc. as described above may be made, so that the answers to these questions are input. The input data are stored in the input result storage DB 102 (step S303).

The input data are then read from the input result storage DB 102 at the server 70 (step S304), and the analysis parameters are read from the analysis parameter DB 103 (step S305).

Thereafter, the input result are analyzed through analysis algorithm such as Bayesian network (step S306), the advice data according to such an analysis result are read from the advice data DB 104 (step S307), transmitted to the user terminal as the analysis result, and displayed on the display screen of the user terminal (step S308).

[System Application Example]

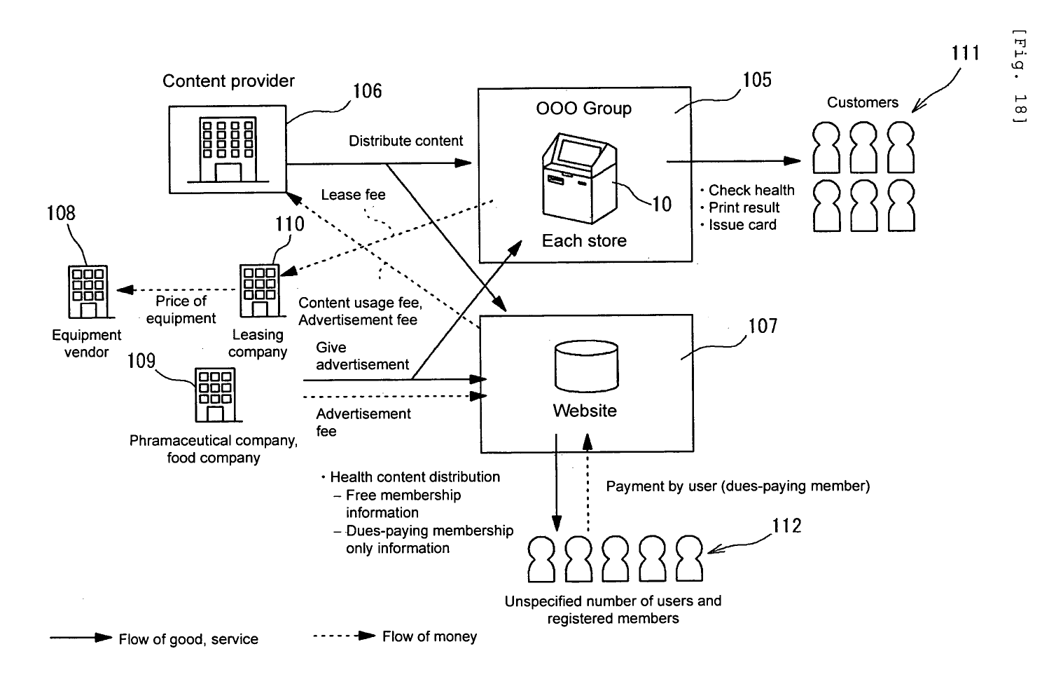

FIG. 18 is a view explaining an example of a business model using the healthcare system of the present invention. In FIG. 18, an industrial group 105 administers a plurality of supermarkets in each of which the store-specific terminal 10 is installed, and a content provider 106 distributes contents to the store-specific terminal 10 and the seller's terminal, and performs maintenance and management of the website 107. The store-specific terminal 10 and the seller's terminal are provided by an equipment vendor 108, and are provided by lease to each store of the industrial group by a leasing company 110.

In FIG. 18, the solid line indicates a flow of “goods” or “services”, and the broken line indicates a flow of “money”. First, store customers 111 comes to the store installed with the store-specific terminal 10, and inputs the daily life information using the store-specific terminal 10 and measures blood pressure etc. to input the result to the store-specific terminal 10, as described above, so that health check can be carried out, and a report including the health support information printed thereon is acquired. If the customer registers for a membership, an ID card is issued. When becoming a member, the past measurement results, health support information etc. are accumulated in the database, whereby the member can carry out his/her health management using the store-specific terminal 10. Advice on health or advice on an appropriate product such as a health supplement for maintaining or improving health may be given by a salesperson in the store.

The registered member or unspecified number of users 112 access the website 107 to acquire the information on health, where the registered member can input the daily life information via the website 107 to perform simple questioning in order to acquire the health support information. Services such as provision of more detailed information are provided to dues-paying members among the members.

A pharmaceutical company or food company may put up an advertisement, through which the registered members as well as unspecified number of users 112 may acquire various information on health. The unspecified number of users are expected to come to the store to receive services of detailed health check using the daily life information and biological information.

The content usage fee paid by due-paying member and an advertisement fee flow to the content provider 106, and the industrial group 105 pays for a lease fee of the store-specific terminal 10 and the seller's terminal to the leasing company 110. With regards to the store, increase in sales of products in the store, and acquisition of regular customers can be expected. Furthermore, an e-commerce site run by the industrial group 105 may be linked to the website 107, so that the registered members and unspecified number of users 112 can purchase products using the e-commerce.

With regards to the user, the health support information can be easily acquired at any time at home, and the health information (information including the past biological information and the health support information) specific to himself/herself can be easily managed by becoming a member. The product suitable for his/her health condition can be purchased at home, and thus is very convenient.

The example shown in FIG. 18 is merely illustration including the flows of “goods”, “services”, and “money”, but various business models can be built according to types of stores, contracts among system participants etc.

What is claimed is:

1. A healthcare system comprising:
a store-specific terminal including:
first input means for accepting an ID of a user, daily life information on daily life of the user, and biological information on the user; and
first transmitting means for transmitting the ID, the daily life information and the biological information on the user accepted by the first input means;
health information registering system including:
first receiving means for receiving the ID, the daily life information and the biological information on the user transmitted from the store-specific terminal,
generating means for generating healthcare support information used for healthcare of the user based on at least the daily life information received by the first receiving means, and
a database for registering the ID, the daily life information, and the biological information on the user received by the first receiving means and the healthcare support information generated by the generating means; and
a user terminal including an output means for outputting the healthcare support information registered in the database;
wherein the user terminal includes:
second input means for accepting the ID of the user; and
second transmitting means for transmitting the ID of the user accepted by the second input means,
wherein the health information registering system includes:
second receiving means for receiving the ID of the user transmitted from the user terminal;
searching means for searching from the database the healthcare support information corresponding to the ID of the user received by the second receiving means; and
third transmitting means for transmitting the healthcare support information searched by the searching means to the user terminal.

2. The healthcare system according to claim 1, wherein
the health information registering system further includes an analysis parameter database for storing an analysis parameter for analyzing the daily life information and the biological information, and
the generating means analyzes at least the daily life information based on the analysis parameter to generate the healthcare support information.

3. The healthcare system according to claim 1, wherein
the second input means accepts the daily life information with the ID of the user,
the second transmitting means transmits the ID of the user and the daily life information accepted by the second input means,
the first receiving means receives the ID of the user and the daily life information transmitted from the user terminal,
the generating means generates the healthcare support information based on the daily life information received by the first receiving means, and
the database further registers the ID of the user and the daily life information received by the first receiving means and the healthcare support information generated by the generating means.

4. The healthcare system according to claim 1, wherein
the healthcare support information includes product information for maintaining or improving health condition of the user.

5. The healthcare system according to claim 1, wherein
the healthcare support information includes advice information for improving health of the user.

6. The healthcare system according to claim 1, wherein
the daily life information includes work description, working hours, sleeping hours, meal description of the user, and a symptom felt by the user.

7. The healthcare system according to claim 1, wherein
the biological information includes a hemoglobin concentration value, a body fat value indicating body fat, a blood flow value indicating blood flow, and a blood pressure value indicating blood pressure of the user.

8. The healthcare system according to claim 7, wherein
the first input means has:
a hemoglobin concentration measuring device for measuring hemoglobin concentration;
a body fat measuring device for measuring body fat;
a blood flow measuring device for measuring blood flow; and
a blood pressure measuring device for measuring blood pressure.

9. A healthcare system comprising:
a health information registering system including:
first storage means for storing user specifying information for specifying a user and healthcare support information used for healthcare of the user in association with each other; and
second storage means for storing, in association with each other, the user specifying information and second user specifying information for specifying a second user permitted by the user specified by the user specifying information to browse the healthcare support information; and
a user terminal including output means for outputting the healthcare support information registered in the healthcare information registering system; wherein
the user terminal includes:
request means for requesting to log-in the healthcare registering system,
the health information registering system includes:
authenticating means for executing log-in authentication in response to a log-in request accepted from the user terminal;
first acquiring means for acquiring from the second storage means the second user specifying information corresponding to the specifying information for specifying the user authenticated by the authenticating means;
second acquiring means for acquiring from the first storage means healthcare support information corresponding to the second user specifying information acquired by the first acquiring means; and
second transmitting means for transmitting to the user terminal the healthcare support information acquired by the second acquiring means.

10. The healthcare system according to claim 9, wherein
the user terminal includes first input means for accepting the second user specifying information and daily life information on daily life of the second user,
the second transmitting means transmits the second user specifying information and the daily life information accepted by the first input means,
the health information registering system includes:
first receiving means for receiving the second user specifying information and the daily life information transmitted from the user terminal; and
generating means for generating the healthcare support information based on the second user daily life information received by the first receiving means, and
the first storage means stores the second user daily life information received by the first receiving means, and further stores the second user specifying information and the second user healthcare support information generated by the generating means in association with each other.

11. The healthcare system according to claim 10, further comprising:
store-specific terminal including:
second input means for accepting the second user specifying information, the daily life information and biological information on the second user, and
second transmitting means for transmitting the second user specifying information, the daily life information, and the biological information accepted by the second input means; wherein
the first receiving means receives the second user specifying information and the daily life information transmitted from the store-specific terminal,
the generating means generates the healthcare support information based on at least the second user daily life information received by the first receiving means,
the first storage means stores the second user specifying information received by the first receiving means and the healthcare support information generated by the generating means in association with each other, and
the second transmitting means transmits the healthcare support information acquired by the second acquiring means to the user terminal.

12. The healthcare system according to claim 10, wherein
the healthcare support information includes product information for maintaining or improving health condition of the second user.

13. The healthcare system according to claim 10, wherein
the healthcare support information includes advice information for improving health of the second user.

14. The healthcare system according to claim 10, wherein
the daily life information includes work description, working hours, sleeping hours, meal description of the second user and a symptom felt by the second user.

15. The healthcare system according to claim 10, wherein
the biological information includes a hemoglobin concentration value, a body fat value indicating body fat, a blood flow value indicating blood blow, and a blood pressure value indicating blood pressure of the second user.

16. The healthcare system according to claim 15, wherein
the second input means has:
a hemoglobin concentration measuring device for measuring hemoglobin concentration;
a body fat measuring device for measuring body fat;
a blood flow measuring device for measuring blood flow; and
a blood pressure measuring device for measuring blood pressure.

17. A healthcare information registering device comprising:
first storage means for storing user specifying information for specifying a user and healthcare support information used for healthcare of the user in association with each other;
second storage means for storing in association with each other the user specifying information and second user specifying information for specifying a second user permitted by the user specified by the user specifying information to browse the healthcare support information;
authenticating means for executing log-in authentication in response to a log-in request accepted from a user terminal;
first acquiring means for acquiring from the second storage means second user specifying information corresponding to the specifying information for specifying the user authenticated by the authenticating means;
second acquiring means for acquiring from the first storage means healthcare support information corresponding to the second user specifying information acquired by the first acquiring means; and
second transmitting means for transmitting the second user healthcare support information acquired by the second acquiring means to the user terminal.

18. The healthcare information registering device according to claim 17, wherein
the healthcare support information includes product information for maintaining or improving health condition of the second user.

19. The healthcare information registering device according to claim 17, wherein
the healthcare support information includes advice information for improving health of the second user.
